(19) United States
(12) Patent Application Publication
(10) Pub. No.: US 2017/0351418 A1
(43) Pub. Date: Dec. 7, 2017

(54) DISPLAY DEVICE AND NON-TRANSITORY COMPUTER-READABLE RECORDING MEDIUM HAVING DISPLAY CONTROL PROGRAM RECORDED THEREON

(71) Applicant: KYOCERA Document Solutions Inc., Osaka (JP)

(72) Inventors: Shoichi SAKAGUCHI, Osaka (JP); Tetsuya NISHINO, Osaka (JP)

(73) Assignee: KYOCERA Document Solutions Inc., Osaka (JP)

(21) Appl. No.: 15/598,618

(22) Filed: May 18, 2017

(30) Foreign Application Priority Data
Jun. 3, 2016 (JP) 2016-112083

(51) Int. Cl. G06F 3/0485; G06F 3/0488

(52) U.S. Cl. CPC G06F 3/04855; G06F 3/04886

(57) ABSTRACT

A display device includes a touch panel display unit and a control unit including a processor that executes an operation program to control a display on the display unit and receive an instruction made by touching the display unit and detected by the touch panel function. The control unit performs, upon receipt of a scroll instruction made by the touching, scrollable display of a screen in the display unit, displays in a display region a scroll bar indicating, by a position thereof in the display region, which part of the image to be displayed is currently displayed on the screen, and displays, before the scrollable display ends, a stop position image indicating a stop position of the scroll bar in the display region, calculated from a display end position of the image displayed according to the scroll instruction, at a position corresponding to the stop position.

### INCORPORATION BY REFERENCE

This application claims priority to Japanese Patent Application No. 2016-112083 filed on Jun. 3, 2016, the entire contents of which are incorporated by reference herein.

### BACKGROUND

The present disclosure relates to a display device, and a non-transitory computer-readable recording medium having a display control program recorded thereon, and in particular to a technique to scroll an image displayed on a display unit.

These days, mobile apparatuses such as mobile phones, smartphones, personal digital assistants (PDA), music players, and electronic tablets have come to be widely utilized. Display devices of many of the mobile apparatuses are configured to display the screen so as to scroll according to a touch operation of a user performed on the screen of the display unit.

Many of the existing display devices have an inertial scroll function to gradually reduce the scrolling speed as if by inertia, when the screen is being scrolled by a swipe operation (sliding a finger while keeping the finger in contact with the screen), instead of immediately stopping the scrolling movement when the user's finger is separated from the screen.

In addition, many of the display devices are configured to display, while the scrollable display is in process, a scroll bar indicating which part of the entire content is currently displayed on the screen of the display unit. Further, various techniques have been proposed to improve the operability of the display device by utilizing the scroll bar.

### SUMMARY

The disclosure proposes further improvement of the foregoing technique. In an aspect, the disclosure provides a display device including a display unit and a control unit. The display unit has a touch panel function. The control unit includes a processor that operates according to an operation program, to allow the control unit to control a display on the display unit and receive an instruction made through a touch operation on the display unit and detected through the touch panel function. The control unit (i) performs, upon receipt of a scroll instruction made through the touch operation with respect to an image to be displayed on the display unit, scrollable display of a screen displayed in the display unit, (ii) displays, in a display region in the display unit, a scroll bar indicating, by a position thereof in the display region, to which part of an entirety of the image to be scrollably displayed a partial image displayed on the screen corresponds, and (iii) displays, before the scrollable display ends, a stop position image indicating a stop position of the scroll bar in the display region, calculated from a display end position of the image to be scrollably displayed according to the scroll instruction, at a position corresponding to the stop position.

In another aspect, the disclosure provides a non-transitory computer-readable recording medium containing a display control program that causes a computer to act as a controller that controls a display on a display unit and receives an instruction made through a touch operation on the display unit and detected through a touch panel function installed in the display unit. The display control program further causes the controller to: (i) perform, upon receipt of a scroll instruction made through the touch operation, scrollable display of a screen displayed in the display unit; (ii) display, in a display region in the display unit, a scroll bar indicating, by a position thereof in the display region, to which part of an entirety of the image to be scrollably displayed a partial image displayed on the screen corresponds; and (iii) display, before the scrollable display ends, a stop position image indicating a stop position of the scroll bar in the display region, calculated from a display end position of the image to be scrollably displayed according to the scroll instruction, at a position corresponding to the stop position.

### BRIEF DESCRIPTION OF THE DRAWINGS

FIG. 1 is a plan view showing an appearance of a display device according to a first embodiment of the disclosure.

FIG. 2 is a functional block diagram showing an essential internal configuration of the display device according to the first embodiment.

FIG. 3 is a schematic drawing showing an example of an incoming mail list image.

FIG. 4 is a plan view showing an example of a screen displayed on a display unit.

FIG. 5A is a plan view showing a scroll bar displayed on the screen of the display unit.

FIG. 5B is a plan view for explaining a scroll bar display region displayed on the screen of the display unit.

FIG. 6 is a flowchart showing a display process performed by the display device according to the first embodiment.

FIG. 7 is a plan view showing another example of the screen displayed on the display unit.

FIG. 8A is a plan view showing a movement caused by a swipe operation on the screen of the display unit.

FIG. 8B is a plan view showing a state at the start of scrollable display on the screen of the display unit.

FIG. 9A is a plan view showing a state where the scrollable display is in process on the screen of the display unit.

FIG. 9B is a plan view showing a state where the scrollable display has ended on the screen of the display unit.

FIG. 10 is a flowchart showing a display process performed by a display device according to a second embodiment.

FIG. 11 is a plan view showing an example of a screen displayed on a display unit.

FIG. 12A is a plan view showing a state where the scrollable display is in process on the screen of the display unit.

FIG. 12B is a plan view showing a state where the scrollable display has ended on the screen of the display unit.

### DETAILED DESCRIPTION

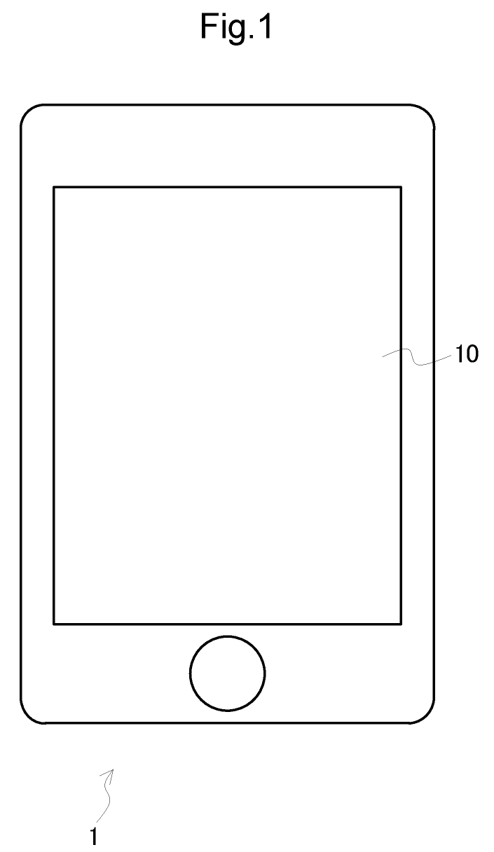

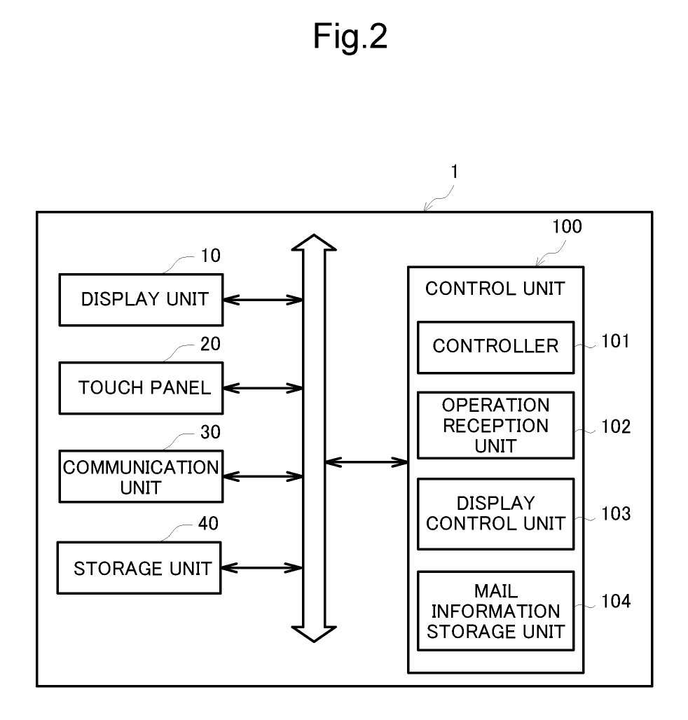

Hereafter, a display device and a display control program according to embodiments of the disclosure will be described with reference to the drawings. FIG. 1 is a plan view showing an appearance of the display device according to a first embodiment of the disclosure. FIG. 2 is a functional block diagram showing an essential internal configuration of the display device according to the first embodiment.

The display device 1 according to the first embodiment of the disclosure may be exemplified by a mobile apparatus such as a smartphone. The display device 1 includes a display unit 10, a touch panel 20, a communication unit 30, a storage unit 40, and a control unit 100. These components are configured to exchange data or signals with each other, via a bus of a central processing unit (CPU).

The display unit 10 is constituted, for example, of a liquid crystal display (LCD) or an organic light-emitting diode (OLED). The display unit 10 displays responses from the control unit 100 and data processing results.

The touch panel 20 may be of a resistive film type or an electrostatic capacitance type. The touch panel 20 is located on the front face of the display unit 10, and detects contact made by a user, as well as the position where the contact has been made, on the screen of the display unit 10. Upon detecting a contact made by the user, the touch panel 20 outputs a detection signal indicating the coordinate position of the contact point, to an operation reception unit 102, to be subsequently described, of the control unit 100. Thus, the touch panel 20 serves as an operation unit through which the user operation with respect to the screen of the display unit 10 is inputted.

The touch panel 20 also includes those configured to detect, for example, the user's finger when the finger comes close to the screen to a predetermined distance, despite a direct contact of the finger not being made on the screen. Accordingly, the term “contact” used in this embodiment encompasses the case where the touch panel 20 detects the finger or other objects that have entered a predetermined range from the screen, though the direct contact has not been made.

The display device 1 may also include physical keys for use of an operation unit for inputting the user's operation, in addition to the touch panel 20. Examples of the physical key include arrow keys, a page-up key, and a page-down key.

The communication unit 30 is a communication interface including a communication module having a non-illustrated local area network (LAN) chip. The display device 1 is connected to other electronic apparatuses such as a personal computer (PC) via a network, and exchanges data with the PC or other apparatuses connected via the communication unit 30.

The storage unit 40 is a storage device, for example a non-volatile memory

The control unit 100 is constituted of a processor, a random-access memory (RAM), a read-only memory (ROM), and so forth. The processor may be, for example, a CPU, a MPU, or an ASIC. The control unit 100 acts as a controller 101, the operation reception unit 102, a display controller 103, and a mail information storage unit 104 when the processor executes a control program stored in the storage unit 40. Here, the components of the control unit 100 may each be constituted in the form of a hardware circuit, instead of being performed according to the display control program. This also applies to other embodiments, unless otherwise specifically noted.

The controller 101 serves to control the overall operation of the display device 1. The controller 101 is connected to the display unit 10, the touch panel 20, the communication unit 30, and the storage unit 40, so as to control these functional units and exchange signals or data therewith. For example, the controller 101 has a mail function for transmitting and receiving mails, and stores the information of the transmitted mails and incoming mails, in the storage unit 104.

The operation reception unit 102 receives a touch operation made on the display unit 10 and detected by the touch panel 20. The operation reception unit 102 identifies the content of the touch operation made by the user according to the detection signal outputted from the touch panel 20, and outputs an instruction representing the identified content to the controller 101 and the display controller 103.

The touch operation made on the touch panel 20 includes a tap operation and a slide operation (including flick operation and swipe operation). For example, when the user puts the finger on the touch panel 20 and then withdraws the finger from the touched position, the touch panel 20 outputs a detection signal indicating the position where the contact has been detected, to the operation reception unit 102. Upon receipt of the detection signal, the operation reception unit 102 identifies that the operation inputted by the user is the tap operation.

When the finger is placed on the touch panel 20 and then moved maintaining the contact therewith, the touch panel 20 outputs a detection signal indicating the locus of the finger between the initial position where the contact has been detected first and the final position where the contact has been detected last, to the operation reception unit 102. Upon receipt the detection signal, the operation reception unit 102 identifies that the operation inputted by the user is the slide operation (flick operation or swipe operation).

The display controller 103 controls the display in the display unit 10. For example, upon receipt of a user's display instruction of an incoming mail list, an example of the image to be displayed, from the operation reception unit 102, the display controller 103 reads incoming mail information from the mail information storage unit 104, generates an incoming mail list image representing the incoming mail information read out, and displays the incoming mail list image on the display unit 10. Here, the incoming mail list image exemplifies the list image in What is claimed is.

When the operation reception unit 102 identifies that, for example, the touch operation made by the user is the swipe operation, the display controller 103 performs a scrollable display in which the scrolling speed is gradually reduced according to the direction and speed of the swipe operation (inertial scroll). The operation reception unit 102 detects the direction of the swipe operation according to the moving direction of the finger in contact with the touch panel 20, and the speed of the swipe operation on the basis of the travel distance per unit time. Although the description given hereunder refers to the case where the swipe operation is performed, the disclosure is equally applicable to the cases where the operation reception unit 102 and the display controller 103 are operated on the basis of other touch operations such as the flick operation.

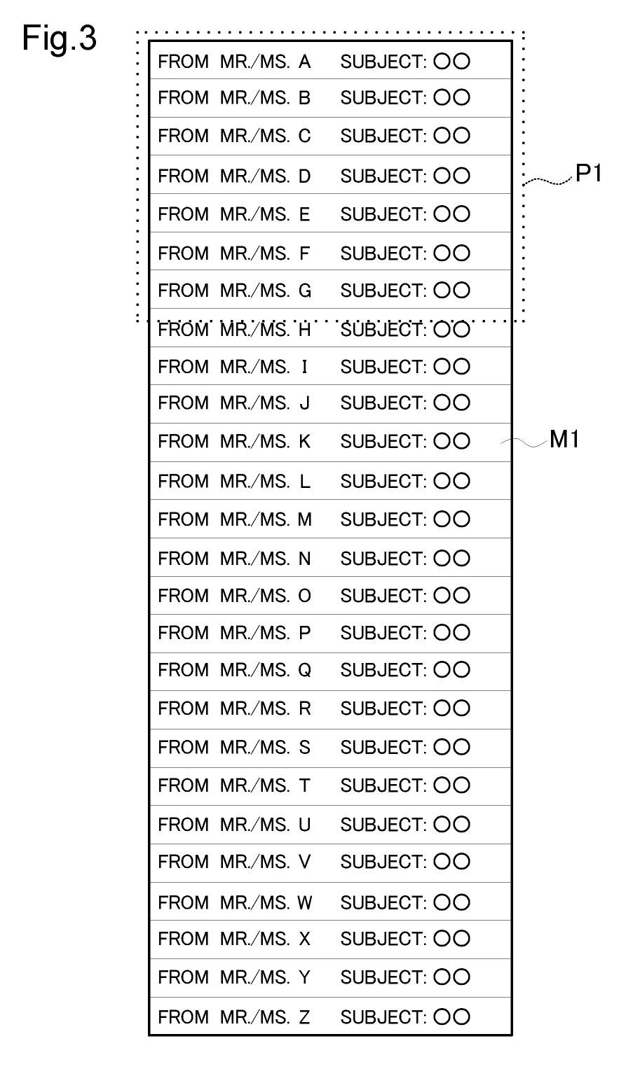

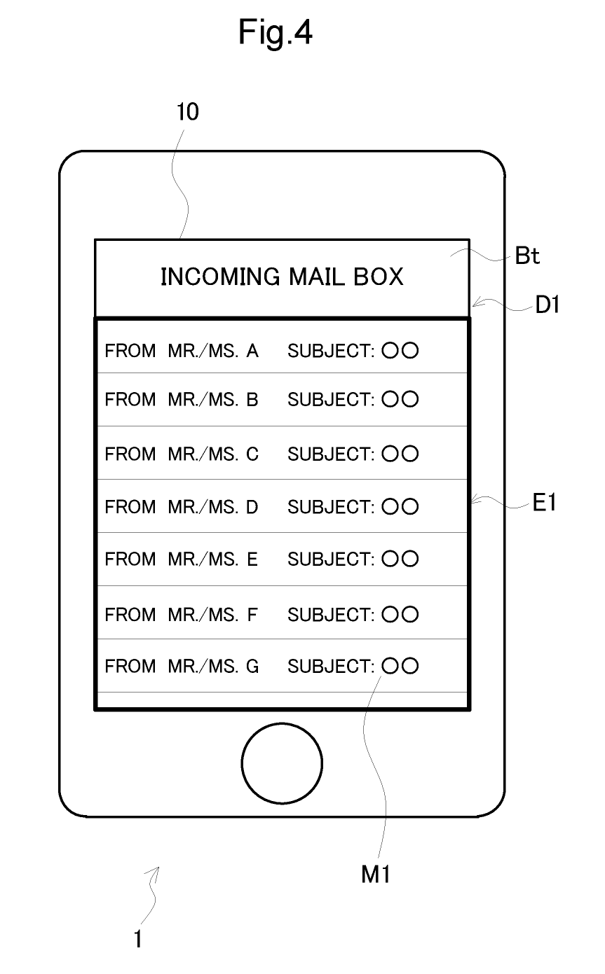

FIG. 3 is a schematic drawing showing an example of the incoming mail list image, and FIG. 4 is a plan view showing an example of the screen displayed on the display unit 10.

In the case where the incoming mail list image M1 protrudes from the display region of the display unit 10 because of a large volume of the incoming mail information as result of generating the incoming mail list image M1, the display controller 103 performs the scrollable display so as to sequentially display divided portions of the incoming mail list image M1 in the display region E1. In this embodiment, the image displayed by the display controller 103 on the display unit 10 as object of the scrollable display will be referred to as scrollable image. Therefore, the scrollable image is an image the entirety of which is unable to be displayed at a time in the display region of the display unit 10, in other words an image the entirety of which is unable to be displayed in the display region unless the divided portions are sequentially displayed in the display region by the scrollable display. The incoming mail list image M1 containing a large volume of incoming mail information exemplifies the scrollable image.

The display controller 103 builds up the screen D1 to be displayed on the display unit 10 with a title bar Bt representing, for example, a title “INCOMING MAIL BOX”, and a partial image of the incoming mail list image M1 located in the display region E1. In this embodiment, the display region E1 will be defined as a region in the screen of the display unit 10 other than the section where the title bar Bt is displayed. A portion P1 indicated by broken lines in FIG. 3 is displayed in the display region E1 shown in FIG. 4. Here, the portion P1 exemplifies the partial list image in What is claimed is.

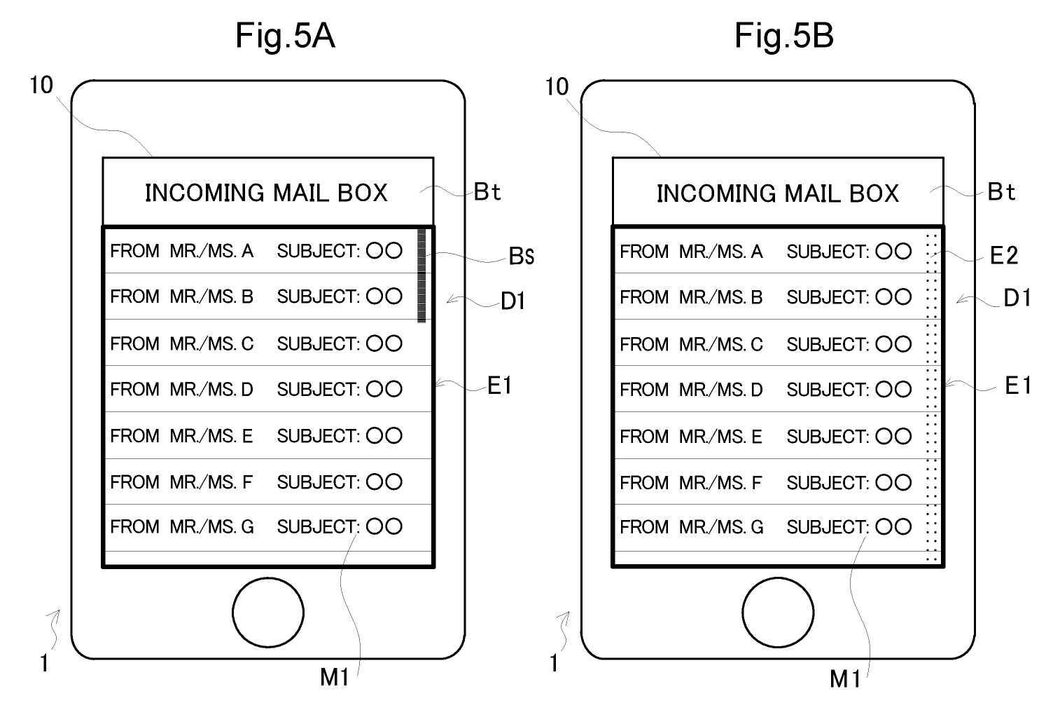

To perform the scrollable display of the incoming mail list image M1, the display controller 103 displays, as shown in FIG. 5A, an image of the scroll bar Bs indicating, by the position thereof in the display region E1, to which part of the entirety of the incoming mail list image M1 (see FIG. 3) the portion P1 displayed in the display region E1 corresponds.

A region indicated by broken lines in FIG. 5B represents a scroll bar display region E2 in which the scroll bar Bs can be displayed. Although the display controller 103 does not display the scroll bar display region E2, the scroll bar display region E2 may be displayed, for example, so as to extend throughout the entire length of the display region E1 (in FIG. 5B, the entire length in the vertical direction).

FIG. 5A illustrates an example in which the display controller 103 displays the scroll bar Bs so as to extend from the upper end of the scroll bar display region E2 to a position corresponding to 30% of the entire length of the scroll bar display region E2 from the upper end thereof. In this case, the scroll bar Bs indicates that the portion P1 displayed in the display region E1 corresponds to a region that covers 30% of the entire length of the incoming mail list image M1 from the upper end thereof. Thus, the scroll bar Bs indicates, by the position thereof in the display region E1, to which part of the entirety of the incoming mail list image M1 (see FIG. 3) the portion P1 displayed in the display region E1 corresponds.

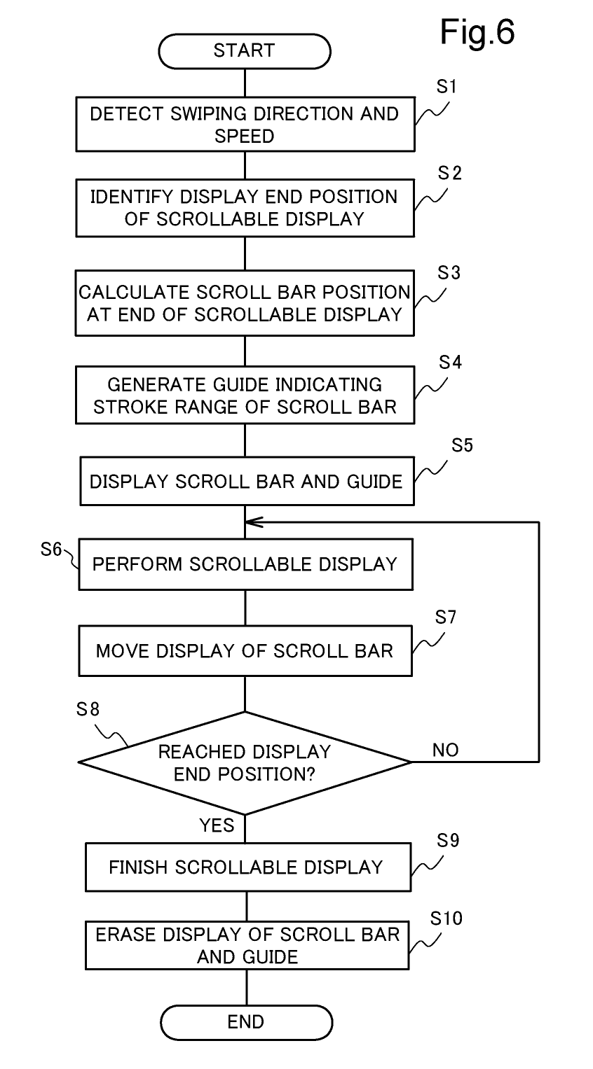

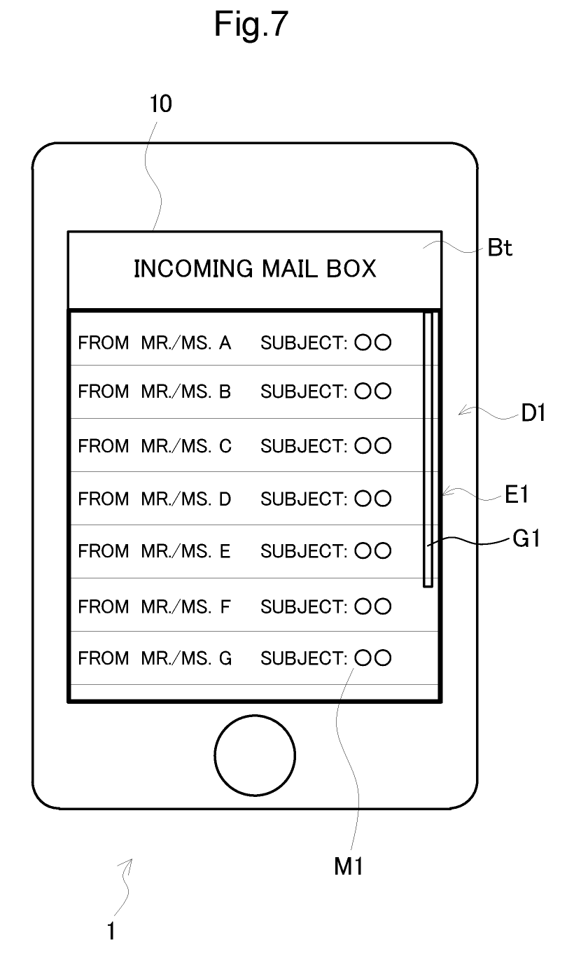

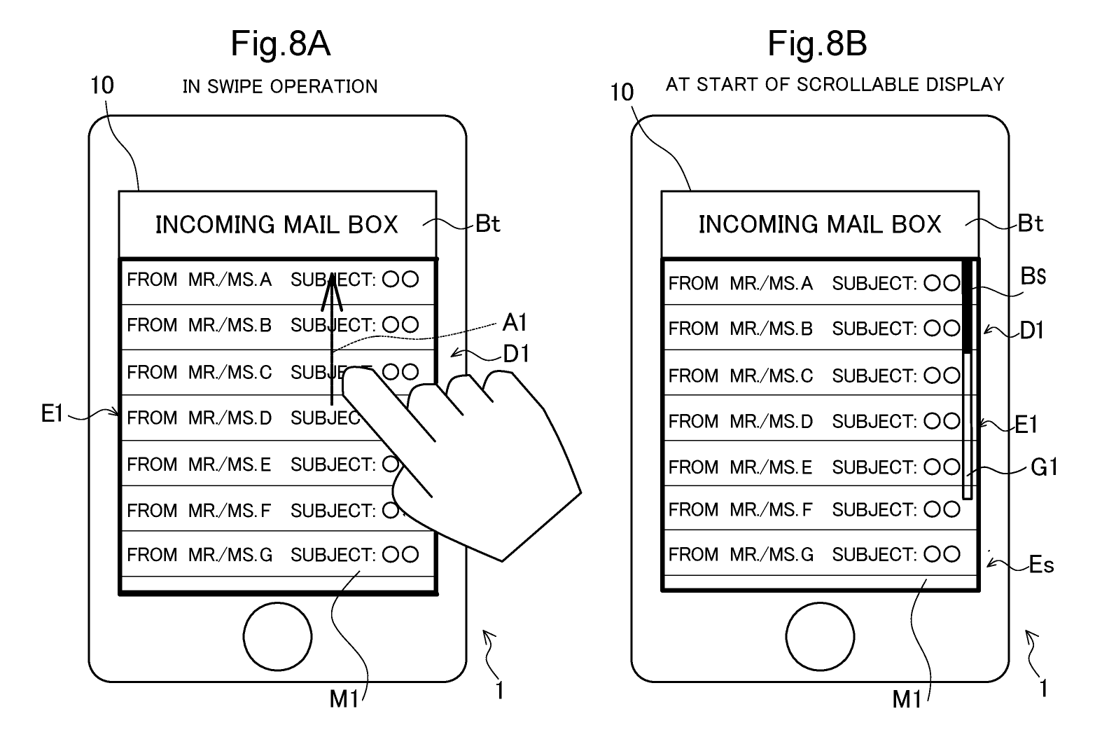

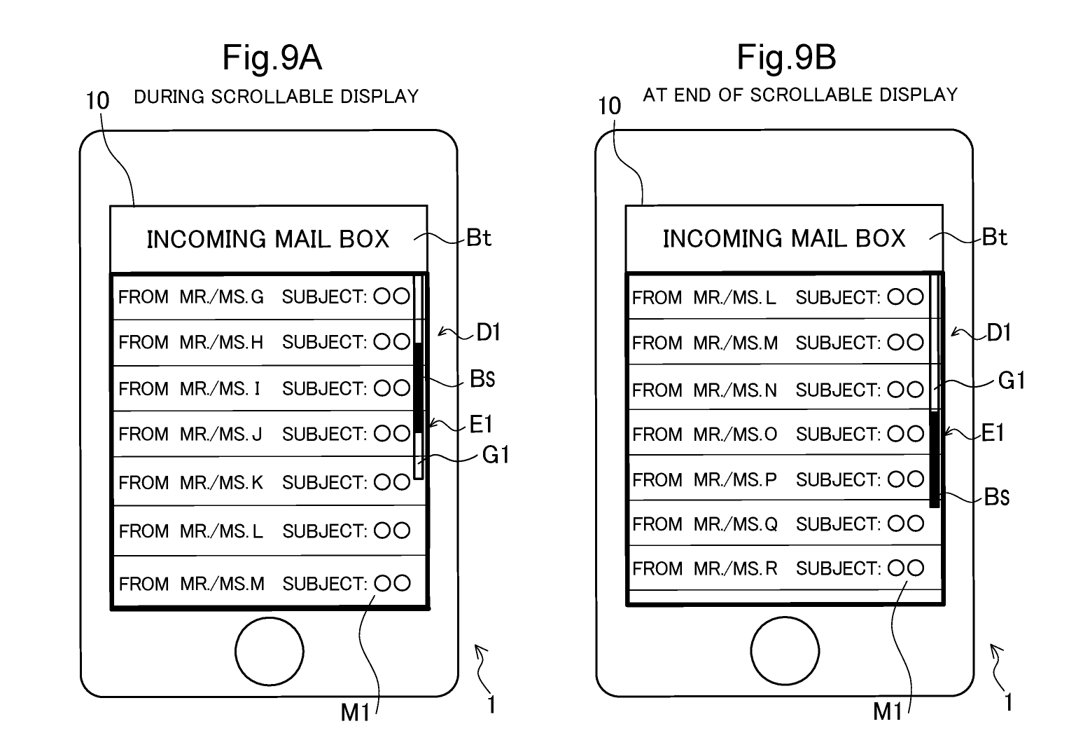

Hereunder, a display process performed by the display device 1 will be described. FIG. 6 is a flowchart showing the display process performed by the display device 1. FIG. 7, FIG. 8A, FIG. 8B, FIG. 9A, and FIG. 9B each illustrate an example of the screen displayed on the display unit 10. Specifically, FIG. 8A represents a screen under the swipe operation, FIG. 8B represents a screen at the start of the scrollable display, FIG. 9A represents a screen that appears during the scrollable display, and FIG. 9B represents a screen at the end of the scrollable display. The description given hereunder refers to the case where the swipe operation is performed on the incoming mail list image M1 when the incoming mail list image M1 is displayed on the display unit 10 as scrollable image (see FIG. 4).

Referring to FIG. 8A, when the user performs, for example, the swipe operation in a direction of an arrow A1 (upward in FIG. 8A) on the incoming mail list image M1 and the operation reception unit 102 detects the swipe operation, the operation reception unit 102 receives the scroll instruction made through the swipe operation, and detects the direction and speed of the swipe operation (S1). The operation reception unit 102 calculates a scroll amount to be applied to the incoming mail list image M1 on the basis of the direction and speed of the swipe operation detected and the display position of the incoming mail list image M1 displayed at this point on the display unit 10, and identifies a display end position of the scrollable display in the incoming mail list image M1 (S2). The operation reception unit 102 then outputs the direction and speed of the swipe operation detected at S1, the display end position of the scrollable display identified at S2, and the scroll instruction, to the display controller 103.

Then the display controller 103 calculates a position in the entire length of the scroll bar display region E2 where the scroll bar Bs is supposed to be displayed at the end of the scrollable display (which may also be defined as the position of the scroll bar Bs displayed in the display region E1 at the end of the scrollable display), on the basis of the display end position identified as above (S3). Further, the display controller 103 generates a guide image G1 of a rectangular shape for example (see FIG. 7), extending from the upper end of the scroll bar display region E2 to the position calculated at S3 (S4). Accordingly, the guide image G1 indicates a stroke range in which the scroll bar Bs is movably displayed while the scrollable display is being performed. The display controller 103 displays the generated guide image G1 in the scroll bar display region E2, as shown in FIG. 7 (S5). The display controller 103 further displays the scroll bar Bs so as to overlap the guide image G1 (S5). For example, as shown in FIG. 8B, the display controller 103 displays the scroll bar Bs so as to overlap the guide image G1, at the position in the display region E1 corresponding to the position of the image displayed in the display region E1 and representing the part of the entirety of the incoming mail list image M1 (see FIG. 3) currently displayed on the display unit 10 (i.e., position in the entire length of the guide image G1). Here, the guide image G1 exemplifies the stop position image in What is claimed is.

In the case where, for example, the scroll instruction of the scrollable display instructs to scroll up, the display controller 103 displays the scroll bar Bs at the upper end of the scroll bar display region E2, when starting the scrollable display. The display controller 103 then displays the guide image G1 generated at S4 such that the upper end thereof is located at the upper end of the scroll bar display region E2. FIG. 8B illustrates the mentioned situation.

In the case where the scroll instruction of the scrollable display instructs to scroll down, the display controller 103 displays the scroll bar Bs at the lower end of the scroll bar display region E2, when starting the scrollable display. The display controller 103 then displays the guide image G1 generated at S4 such that the lower end thereof is located at the lower end of the scroll bar display region E2.

In either of the mentioned cases, the length of the guide image G1 corresponds to the stroke range of the scroll bar Bs during the scrollable display.

Then the display controller 103 starts the scrollable display of the incoming mail list image M1, in the direction and at the speed of the swipe operation detected at S1 (S6). The display controller 103 moves the display position of the scroll bar Bs, in accordance with the transition of the display in the display region E1 for performing the scrollable display (S7). In this case, the display controller 103 shifts the display position of the scroll bar Bs in the entire length of the guide image G1, according to which part of the incoming mail list image M1 the portion P1 displayed in the display region E1 corresponds to, as shown in FIG. 9A.

Referring to FIG. 9B, the display controller 103 performs the scrollable display and the movable display of the scroll bar Bs while the portion P1 displayed in the display region E1 is away from the display end position (NO at S8), and when the portion P1 displayed in the display region E1 reaches the display end position (YES at S8), the display controller 103 finishes the scrollable display of the incoming mail list image M1 (S9). The display controller 103 then erases the scroll bar Bs and the guide image G1, upon finishing the scrollable display (S10). The display controller 103 thus finishes the scrollable display and erases the scroll bar Bs and the guide image G1, when the portion P1 reaches the display end position, and therefore the user can visually recognize easily that the entirety of the incoming mail list image M1 has been displayed by being scrolled.

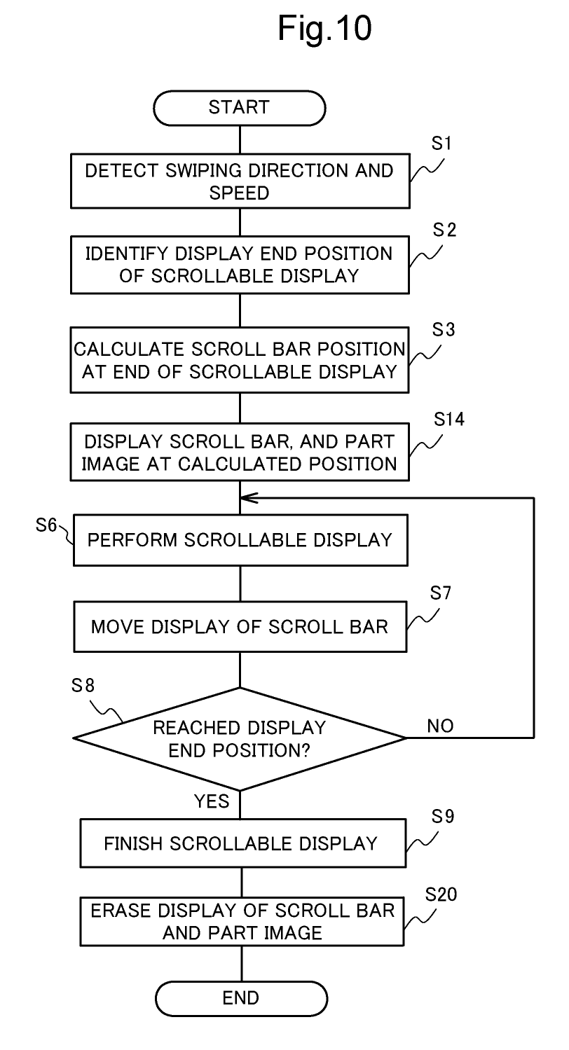

Hereunder, a second embodiment of the display process performed by the display device 1 will be described. FIG. 10 is a flowchart showing the display process performed by the display device 1 according to the second embodiment. The description of the same steps as those of the first embodiment will not be repeated.

Although the guide image G1 indicating the stroke range of the scroll bar Bs is displayed on the display unit 10 according to the first embodiment, the second embodiment is different therefrom in that an image of the same shape as the scroll bar Bs is displayed on the display unit 10 at the position where the scroll bar Bs is supposed to be displayed at the end of the scrollable display.

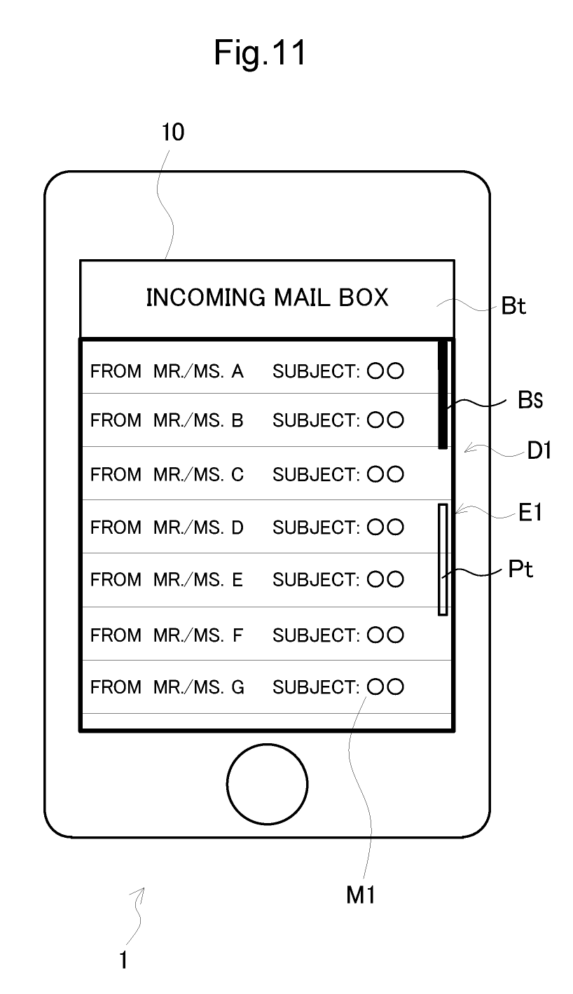

In the second embodiment, the display controller 103 calculates the position in the display region E1 where the scroll bar Bs is to be displayed at the end of the scrollable display, on the basis of the display end position calculated at S2 (S3), and displays, as shown in FIG. 11, a part image Pt of the same shape as the scroll bar Bs on the portion P1 in the display region E1, at the position calculated at S3 (S14). The part image Pt exemplifies the stop position image in the disclosure.

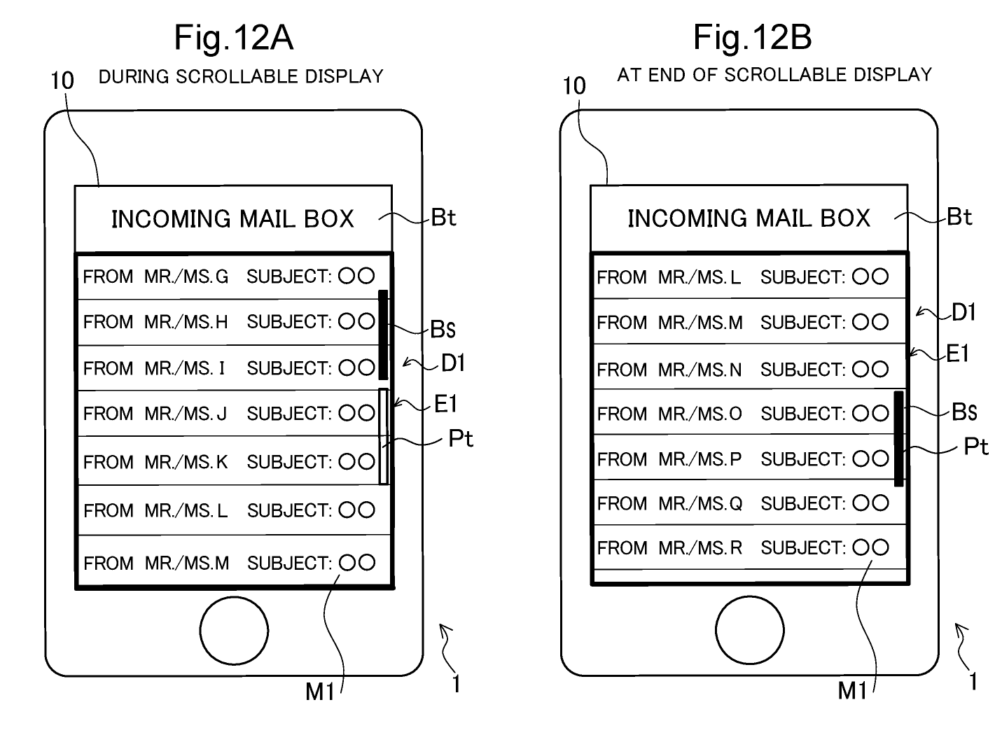

Then the display controller 103 starts the scrollable display of the incoming mail list image M1, in the direction and at the speed of the swipe operation detected at S1 (S6), and moves the display position of the scroll bar Bs, in accordance with the transition of the display in the display region E1 for performing the scrollable display, as shown in FIG. 12A (S7).

Referring to FIG. 12B, the display controller 103 performs the scrollable display and the movable display of the scroll bar Bs while the portion P1 displayed in the display region E1 is away from the display end position (NO at S8), and when the portion P1 displayed in the display region E1 reaches the display end position (YES at S8), the display controller 103 displays the scroll bar Bs so as to overlap the part image Pt, and finishes the scrollable display of the incoming mail list image M1 (S9). The display controller 103 then erases the scroll bar Bs and the part image Pt upon finishing the scrollable display (S20). The display controller 103 thus finishes the scrollable display and erases the scroll bar Bs and the guide image G1, when the portion P1 reaches the display end position, and therefore the user can visually recognize easily that the entirety of the incoming mail list image M1 has been displayed by being scrolled.

In existing display devices, employing the inertial scroll so as not to finish the scrolling motion immediately after the finger is separated from the screen provides an advantage in that the user is alleviated from the trouble of the operation. On the other hand, it is difficult to identify the end position of the display being scrolled. In addition, regarding the existing display devices, a technique to notify the end position where the scrollable display of the entire image ends, to the user in advance, is not disclosed or suggested.

According to the first and second embodiments, in contrast, the scroll bar Bs, as well as the guide image G1 or the part image Pt indicating the stroke range of the scroll bar Bs are displayed on the display unit 10 immediately after the swipe operation and while the display is being scrolled. Therefore, the user can surely recognize in advance the display end position of the display being scrolled, despite that the scrolling motion is not stopped immediately after the swipe operation.

The disclosure is not limited to the foregoing embodiment, but may be modified in various manners. For example, although the display device according to the foregoing embodiments of the disclosure is exemplified by the smartphone, the disclosure is equally applicable to different electronic apparatuses, such as a mobile phone, a PDA, a music player, and an electronic tablet.

The configurations and processing according to the foregoing embodiments, described above with reference to FIG. 1 to FIG. 12B, are merely exemplary and in no way intended to limit the configurations and processing of the disclosure.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. A display device comprising:
a display unit having a touch panel function; and
a control unit including a processor that operates according to an operation program, to allow the control unit to control a display on the display unit and receive an instruction made through a touch operation on the display unit and detected through the touch panel function,
wherein the control unit performs, upon receipt of a scroll instruction made through the touch operation with respect to an image to be displayed on the display unit, scrollable display of a screen displayed in the display unit,
displays, in a display region in the display unit, a scroll bar indicating, by a position thereof in the display region, to which part of an entirety of the image to be scrollably displayed a partial image displayed on the screen corresponds, and
displays, before the scrollable display ends, a stop position image indicating a stop position of the scroll bar in the display region, calculated from a display end position of the image to be scrollably displayed according to the scroll instruction, at a position corresponding to the stop position.

2. The display device according to claim 1,
wherein the control unit generates, as the stop position image, a guide image indicating a stroke range in which the scroll bar moves while the scrollable display is performed, and displays the generated guide image in the display region.

3. The display device according to claim 1,
wherein the control unit generates, as the stop position image, a part image indicating a position of the scroll bar to be displayed in the display region at an end of the scrollable display, and displays the generated part image in the display region.

4. The display device according to claim 1,
wherein the control unit finishes the scrollable display when the partial image reaches the display end position owing to the touch operation, and erases the scroll bar and the stop position image.

5. The display device according to claim 1,
wherein the control unit displays a list image as the image to be displayed,
performs the scrollable display of the screen displayed in the display unit when an operation reception unit receives the scroll instruction made through the touch operation with respect to the list image,
displays, in the display region, a scroll bar indicating, by a position thereof in the display region, to which part of an entirety of the list image to be scrollably displayed a partial list image displayed on the screen corresponds, and
displays, in a case where the scroll instruction is made through a slide operation, a stop position image indicating a stop position of the scroll bar in the display region, calculated from a display end position of the list image scrollably displayed according to a direction and speed of the slide operation, at a position corresponding to the stop position, before the scrollable display ends.

6. The display device according to claim 5,
wherein the control unit generates, as the stop position image, a guide image indicating a stroke range in which the scroll bar moves while the scrollable display is performed, and displays the generated guide image in the display region.

7. The display device according to claim 5,
wherein the control unit generates, as the stop position image, a part image indicating a position of the scroll bar to be displayed in the display region at an end of the scrollable display, and displays the generated part image in the display region.

8. The display device according to claim 5,
wherein the control unit finishes the scrollable display when the partial list image reaches the display end position owing to the touch operation, and erases the scroll bar and the stop position image.

9. A non-transitory computer-readable recording medium having a display control program recorded thereon, the display control program being configured to cause a computer to act as a controller that controls a display on a display unit and receives an instruction made through a touch operation on the display unit and detected through a touch panel function installed in the display unit,
the display control program being configured to further cause the controller to:
perform, upon receipt of a scroll instruction made through the touch operation, scrollable display of a screen displayed in the display unit;
display, in a display region in the display unit, a scroll bar indicating, by a position thereof in the display region, to which part of an entirety of the image to be scrollably displayed a partial image displayed on the screen corresponds; and
display, before the scrollable display ends, a stop position image indicating a stop position of the scroll bar in the display region, calculated from a display end position of the image to be scrollably displayed according to the scroll instruction, at a position corresponding to the stop position.
